(19) United States
(12) Patent Application Publication
(10) Pub. No.: US 2026/0040262 A1
(43) Pub. Date: Feb. 5, 2026

(54) MECHANISM FOR LOCATION VERIFICATION

(71) Applicant: Nokia Solutions and Networks Oy, Espoo (FI)

(72) Inventor: Mao CAI, Chengdu (CN)

(21) Appl. No.: 19/099,441

(22) PCT Filed: Jul. 29, 2022
(86) PCT No.: PCT/CN2022/108903

§ 371 Date: Jan. 28, 2025

(51) Int. Cl. H04W 64/00; H04W 24/10; H04W 84/06

(52) U.S. Cl. CPC H04W 64/00; H04W 24/10; H04W 84/06

(57) ABSTRACT

Mechanism on location verification is proposed. One or more devices at known location(s) are deployed for verifying location information of a UE. The one or more devices perform a positioning measurement and report the positioning measurement. A core network device verifies the location information based on the reported positioning measurement and positioning measurement from the UE. In this way, it ensures that the location provided by the UE is trusted.

### FIELD

Embodiments of the present disclosure generally relate to communication techniques, and more particularly, to methods, devices and computer readable medium for location verification.

### BACKGROUND

With developments of communication systems, new technologies have been proposed. A communication system can be seen as a facility that enables communication sessions between two or more entities such as user terminals, access nodes or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia or content data and so on. Content may be multicast or uni-cast to communication devices. A user can access the communication system by means of an appropriate communication device or terminal. A communication device of a user is often referred to as user equipment (UE) or user device. The communication device may access a carrier provided by an access node and transmit or receive communications on the carrier.

### SUMMARY

Generally, embodiments of the present disclosure relate to a method for location verification and corresponding devices.
In a first aspect, there is provided a first device. The first device comprises at least one processor; and at least one memory storing instructions that, when executed by the at least one processer, cause the first device at least to: transmit first information to at least one second device. The first information comprises an identity of a non-terrestrial network device to which a third device connects. The first device is also caused to transmit second information to the at least one second device. The second information indicates a first positioning measurement configured for the at least one second device. The first positioning measurement is determined based on a second positioning measurement performed by the third device for the non-terrestrial network device. The first device is also caused to receive from the at least one second device first measurement data which is determined based on the first positioning measurement. The first device is also caused to determine a verification of location information of the third device based on the first measurement data and second measurement data which is determined based on the second positioning measurement.
In a second aspect, there is provided a second device. The second device comprises at least one processor; and at least one memory storing instructions that, when executed by the at least one processor, cause the second device at least to receiving first information from a first device. The first information comprises an identity of a non-terrestrial network device to which a third device connects. The second device is also caused to receive second information from the first device. The second information indicates a first positioning measurement configured for the at least one second device. The first positioning measurement is determined based on a second positioning measurement performed by the third device for the non-terrestrial network device. The second device is also caused to perform the first positioning measurement based on a positioning reference signal from the non-terrestrial network device. The second device is also caused to transmit to the first device first measurement data determined based on at least one of: the first positioning measurement or a first positioning result of the first positioning measurement.
In a third aspect, there is provided a third device. The third device comprises at least one processor; and at least one memory storing instructions that, when executed by the at least one processor, cause the third device at least to transmitting, at a third device, location information of the third device to a first device. The third device is also caused to perform a second positioning measurement based on a positioning reference signal from a non-terrestrial network device. The third device is also caused to transmitting to the first device second measurement data which is determined based on at least one of: the second positioning measurement or a second positioning result of the second positioning measurement.
In a fourth aspect, there is provided a method. The method comprises transmitting, at a first device, first information to at least one second device. The first information comprises an identity of a non-terrestrial network device to which a third device connects. The method also comprises transmitting second information to the at least one second device. The second information indicates a first positioning measurement configured for the at least one second device. The first positioning measurement is determined based on a second positioning measurement performed by the third device for the non-terrestrial network device. The method also comprises receiving from the at least one second device first measurement data which is determined based on the first positioning measurement. The method also comprises determining a verification of location information of the third device based on the first measurement data and second measurement data which is determined based on the second positioning measurement.
In a fifth aspect, there is provided a method. The method comprises receiving, at a second device, first information from a first device. The first information comprises an identity of a non-terrestrial network device to which a third device connects. The method also comprises receiving second information from the first device. The second information indicates a first positioning measurement configured for the at least one second device. The first positioning measurement is determined based on a second positioning measurement performed by the third device for the non-terrestrial network device. The method also comprises performing the first positioning measurement based on a positioning reference signal from the non-terrestrial network device. The method also comprises transmitting to the first device first measurement data determined based on at least one of: the first positioning measurement or a first positioning result of the first positioning measurement.
In a sixth aspect, there is provided a method. The method comprises transmitting, at a third device, location information of the third device to a first device. The method also comprises performing a second positioning measurement based on a positioning reference signal from a non-terrestrial network device. The method also comprises transmitting to the first device second measurement data which is determined based on at least one of the second positioning measurement or a second positioning result of the second positioning measurement.
In a seventh aspect, there is provided an apparatus. The apparatus comprises means for transmitting, at a first device, first information to at least one second device. The first information comprises an identity of a non-terrestrial network device to which a third device connects. The apparatus also comprises means for transmitting second information to the at least one second device. The second information indicates a first positioning measurement configured for the at least one second device, and the first positioning measurement is determined based on a second positioning measurement performed by the third device for the non-terrestrial network device. The apparatus also comprises means for receiving from the at least one second device first measurement data which is determined based on the first positioning measurement. The apparatus also comprises means for determining a verification of location information of the third device based on the first measurement data and second measurement data which is determined based on the second positioning measurement.
In an eighth aspect, there is provided an apparatus. The apparatus comprises means for receiving, at a second device, first information from a first device. The first information comprises an identity of a non-terrestrial network device to which a third device connects. The apparatus also comprises means for receiving second information from the first device. The second information indicates a first positioning measurement configured for the at least one second device, and the first positioning measurement is determined based on a second positioning measurement performed by the third device for the non-terrestrial network device. The apparatus also comprises means for performing the first positioning measurement based on a positioning reference signal from the non-terrestrial network device. The apparatus also comprises means for transmitting to the first device first measurement data determined based on at least one of the first positioning measurement or a first result of the first positioning measurement.
In a ninth aspect, there is provided an apparatus. The apparatus comprises means for transmitting, at a third device, location information of the third device to a first device. The apparatus comprises means for transmitting, at a third device, location information of the third device to a first device. The apparatus also comprises means for performing a second positioning measurement based on a positioning reference signal from a non-terrestrial network device. The apparatus also comprises means for transmitting to the first device second measurement data which is determined based on at least one of the second positioning measurement or a second result of the second positioning measurement.
In a tenth aspect, there is provided a computer readable medium comprising program instructions for causing an apparatus to perform at least the method according to the above fourth, fifth, or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a communication system according to according to example embodiments of the present disclosure;

FIG. 2 illustrates a schematic diagram of interactions between devices according to according to example embodiments of the present disclosure;

FIG. 3A and FIG. 3B illustrate schematic diagrams of a selection of positioning reference unit (PRU) according to example embodiments of the present disclosure, respectively;

FIG. 4 illustrates a schematic diagram of interactions between devices according to according to example embodiments of the present disclosure;

FIG. 5A and FIG. 5B illustrate schematic diagrams of example scenarios according to example embodiments of the present disclosure, respectively;

FIG. 6 illustrates a schematic diagram of interactions between devices according to according to example embodiments of the present disclosure;

FIG. 7 illustrates a flow chart of a method implemented at a first device according to example embodiments of the present disclosure;

FIG. 8 illustrates a flow chart of a method implemented at a second device according to example embodiments of the present disclosure;

FIG. 9 illustrates a flow chart of a method implemented at a third device according to example embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. The term “non-transitory”, as used herein, is a limitation of the medium itself (i.e., tangible, not a signal) as opposed to a limitation on data storage persistency (e.g., RAM vs. ROM).

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

A public land mobile network (PLMN) is a combination of wireless communication services offered by a specific operator in a specific country. A PLMN may comprise several different cellular technologies, like GSM/2G, UMTS/3G, LTE/4G, offered by a single operator within a given country. The operating license of each PLMN is granted by the local authorities in each country, and it allows each PLMN to operate in that jurisdiction, but not in the other countries/countries not covered by the operating license. In terrestrial systems, the radio network coverage area is designed to follow the national borders with reasonable accuracy. This inaccuracy of PLMN coverage area leaking slightly across the border is an accepted fact, and network operators have tools to address this in the border areas.

A problem arises when considering super-national cell coverage areas i.e. coverage areas that span multiple jurisdictions/countries. This may arise, for example, during satellite provision of 5G network access, which 3GPP Radio Access Network (RAN) groups estimate will ultimately span up to 450 km (see, for example, 3GPP Technical Report (TR) 38.821). Such extremely large single cell coverage area will unavoidably leak substantially across country borders. Consequently, a new mechanism to control a UE's access to available PLMNs is being considered. One of these considered mechanisms is based on a change of the UEs PLMN selection rules to limit the UE to select only those PLMN candidates that are available in the same country as the present UE location. Since there are both financial issues and regulatory requirements at stake, the network may use certain mechanisms to enforce the UEs PLMN selection. This mechanism assumes that currently specified procedures are enhanced to allow the network to obtain a network-determined UE location, although how exactly this UE location enhancement is to be done is not yet specified.

In some mechanisms, a cell identifier and a tracking area (which includes an identifier for the PLMN ID) are used by the network to determine a country in which a UE is currently located. However, for NR satellite access to the network, the cell size can be multi-national (i.e. covering multiple countries/jurisdictions). In such a case, the Cell ID granularity is not a good enough estimate for determining a jurisdiction in which the UE is currently located.

In some mechanisms, the UE can provide its location information to a core network device. However, the location information may not be always trusted. In some mechanisms, artificial intelligence/machine learning (AI/ML) may be used to provide a certain possibility of a verification of the location information. But for regulatory requirements, such uncertainties are not enough. In some mechanisms, the verification of the location information may be assisted by a terrestrial network (TN) access. However, this solution applies only to the area where TN radio and satellite radio overlaps and UE connects to both TN and satellite access. This is a very limited case. In some other mechanisms, the location information may be verified based on obtained information. This solution uses radio access network (RAN) assistance to verify UE-based location estimate (generated by UE). However, this is an incomplete solution.

In order to solve at least part of the above problems and other potential problems, solutions on location verification are proposed. According to example embodiments of the present disclosure, one or more devices at known location(s) are deployed for verifying location information of a UE. The one or more devices perform a positioning measurement and report the positioning measurement. A core network device verifies the location information based on the reported positioning measurement and positioning measurement from the UE. In this way, it ensures that the location of the UE is trusted.

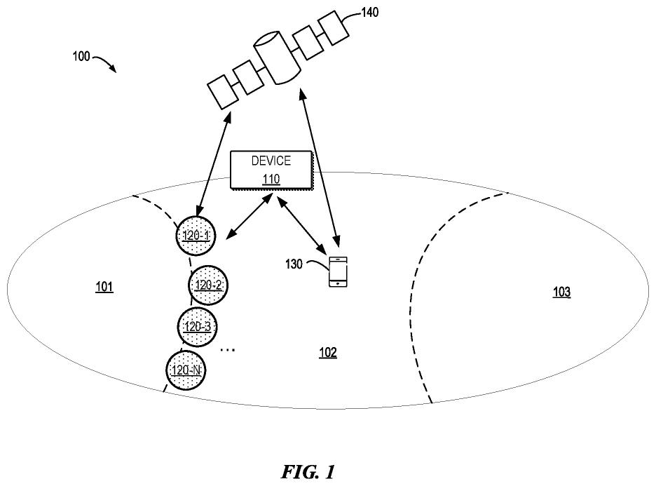

FIG. 1 illustrates a schematic diagram of a communication system in which embodiments of the present disclosure can be implemented. The communication system 100, which is a part of a communication network, includes a device 110. In an example, the device 110 may be a core network device, for example, a location management function (LMF) entity. The communication system 100 includes a device 120-1, a device 120-2, a device 120-3, . . . , and a device 120-N, which can be collectively referred to as “device(s) 120.” In some example embodiments, the device 120 may be a positioning reference unit (PRU). The term “Positioning Reference Unit (PRU)” used herein can refer to a device at a known location can perform positioning measurements (for example, Reference Signal Time Difference (RSTD), Reference Signal Received Power (RSRP), UE Reception-Transmission (Rx-Tx) Time Difference measurements, and the like) and report these measurements to a location server. In some embodiments, the PRU may also perform GNSS measurements. The communication system 100 further includes a device 130. In an example, the device 130 may be a terminal device. The communication system 100 also includes a non-terrestrial network (NTN) device 140, for example, the NTN device 140 may be a satellite. The communication system 100 may also include others device which are not shown, for example, a network device. It is to be understood that the number of devices (110, 120, 130 and 140) shown in FIG. 1 is given for the purpose of illustration without suggesting any limitations. The communication system 100 may include any suitable number of devices and cells.

As shown in FIG. 1, the coverage area of the NTN device 140 may encompasses at least part of three different countries, 101, 102 and 103. The device 130 is currently located in country 102. In FIG. 1, the device 130 may be able to use all PLMNs allowed in countries 101, 103 and 103, with each of these allowed PLMNs only being allowed to operate within the area of their own country. In the roaming situation of FIG. 1, the device 130 may be only allowed to select among PLMNs of Country 102, and the network may be able to police this UE selection. The policing by the network is to avoid theft of service by avoiding roaming charges and criminal activity avoiding lawful interception, which can only be initiated by the public authorities of the same country as the UE location. The following does not need to be limited to country borders, and any form of geodetic area(s) can be applied. For example, there may be defined restricted regions that the UE is not allowed to be located in, and the request may indicate that it is a request to determine whether the UE is outside of this restricted region. The restricted region may come from national or regional regulations, or other requirements.

In the communication system 100, the devices 130 and the device 140 may communicate data and control information to each other through links from the device 140 to the device(s) 130 are referred to as downlink(s) (DL), while links from the device(s) 130 to the device 140 are referred to as uplink(s) (UL). The devices 110, 120 and 140 may also communicate data and control information to each other. The devices 110, 130 and 140 may also communicate data and control information to each other. The devices 110, 120, 130 and 140 may be interchangeable.

Communications in the communication system 100 may be implemented according to any proper communication protocol(s), including, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

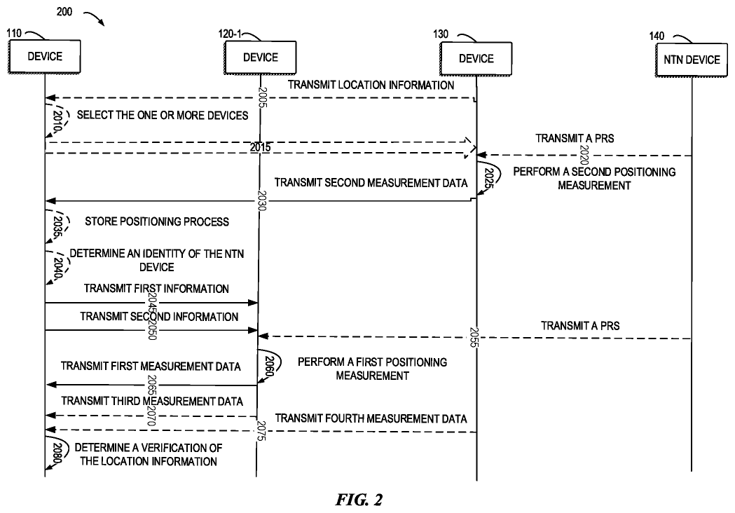

Example embodiments of the present disclosure will be described in detail below with reference to the accompanying drawings. Reference is now made to FIG. 2, which illustrates a signaling flow 200 of data collection according to example embodiments of the present disclosure. Only for the purpose of illustrations, the signaling flow 200 involves the device 110, the device 120-1, the device 130 and the device 140. It is noted that step orders shown in FIG. 2 are only examples not limitations.

The device 130 (referred to as a third device hereinafter) may transmit 2005 its location information to the device 110 (referred to as a first device hereinafter). For example, the location information may indicate that the device 130 is located in country 102.

The device 110 may select 2010 one or more devices (for example, the devices 120-1 and 120-2) based on the location information of the device 110. In this way, it ensures that the devices can be selected properly.

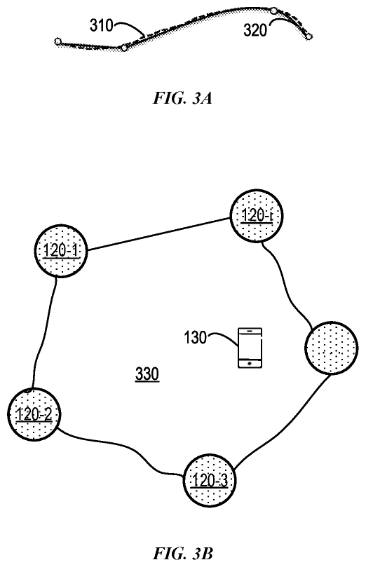

Only as an example, for area in/outside super-national area decision, is may decide which side of the border the device 130 is located. For example, as shown in FIG. 3A, the border line 310 may be fit into a curve function Π(X−Pi)=0, where Pi(x,y) represents a pint coordinate on the border line 310. If the device 130 and the device 120-1 are located on the same side of the border line 310, their coordinates in the curve function (shown as 320 in FIG. 3) may be both positive or both negative, the following may be valid:

$$\prod ( Pue - Pi ) * \prod ( {P}_{PRUi} - Pi ) > 0 \qquad ( 1 )$$

where P_{UE} represents the location of the device 130, P_{PRUi} represents the location of the device 120-I in the area which can be used to identify which side of the border the device 130 may be, and i can be any integer number.

For the enclosed area, it can be broken into separate consecutive curves and perform the above method to decide whether the device 130 is located inside/outside. For example, as shown in FIG. 3B, the devices 120-1, 120-2, 120-3, . . . , 120-I may be deployed alongside the border of area to being determined and enclose the area where the device 130 locates.

Referring black to FIG. 2, the device 110 may transmit 2015 assistance information of positioning reference signal (PRS) measurement to the device 130 and the device 120. In some example embodiments, positioning assistance information may be broadcasted with pos system information block (SIB). In this case, the device 130 may perform the PRS and satellite measurements without explicit request to 5G core (5GC) before/during the registration. During the registration, the device 130 may take the ProvideLocationInformation LTE positioning protocol (LPP) message with PRS and satellite measurements with the registration request for satellite access. The LPP payload may be taken by registration request in initial UE message. The LPP payload may also be carried by a separate UL_NAS_TRANSPORT if ciphering key is available after registration request. When Access and Mobility Management Function (AMF) which is not shown in FIG. 2 receives the registration request, the measurements in LPP message may be forwarded to the device 110 over NL1 interface with Nlmf_Location_DetermineLocation service operation. The device 110 may reply with the country indication and area information associated with the UE.

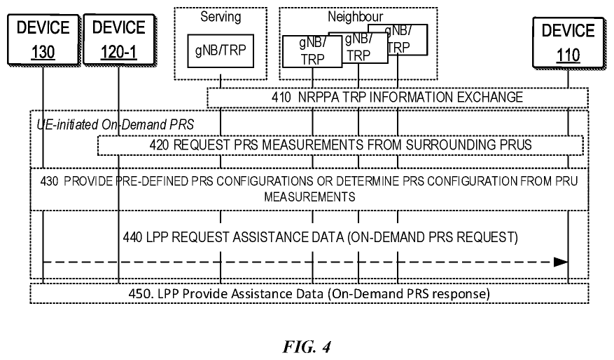

Alternatively, the device 120-1 may transmit a request for a PRS measurement. The device 110 then may transmit 2015 assistance information of positioning reference signal (PRS) measurement to the device 130 and the device 120. For example, as shown in FIG. 4, the device 110 and one or more gNB/transmission reception points (TRPs) may exchange 410 TRP information via NR positioning protocol a (NRPPa). In some example embodiments, UE-initiated on-demand PRS may be performed. The device 120-1 may request 420 PRS measurement to the device 110. The device 110 may provide 430 pre-defined PRS configurations to the devices 130 and 120-1. Alternatively, the device 110 may determine PRS configurations and provide 430 the determined PRS configurations to the devices 130 and 120-1. The device 130 may request 440 assistance data to the device 110. In other words, the device 130 may transmit the on-demand PRS request. The device 110 may provide 450 the assistance data to the devices 120-1 and 130. In some example embodiments, if the PRS is not pre-configured, the device 110 may determine the needed for PRS transmission or change to PRS transmission characteristics. In this case, the device 110 may transmit a PRS configuration request via NRPPa to the one or more gNB/TRPs and the one or more gNB/TRPs may transmit a PRS configuration response via NRPPa to the device 110. In some example embodiments, RSTD window of PRS may be deployed so that the device 130 can only pickup the signal within the specified/claimed area/country. Since the geographic topology of the device 120-1 and the device 130 are known before the verification of the location information of the device 130, RSTD window of PRS assistance may be determined in the device 110. With PRS configured to TRPs and reported from the device 130, the surrounding PRU can also take the measurements and perform the field verification.

In some example embodiments, the device 110 may transmit RequestLocationInformation asking for cell/satellite measurements instead of location estimate over LPP. The device 110 may also send NRPPa message POSITIONING INFORMATION REQUEST for UL measurements.

Referring back to FIG. 2, the NTN device 140 may transmit 2020 one or more PRSs to the device 130. The device 130 may monitor the plurality of PRRs based on the assistance information regarding PRS.

The device 130 performs 2025 a second positioning measurement based on the one or more PRSs from the NTN device 140. In some embodiments, the device 130 may determine timestamp information which is associated with the first and second positioning measurements. For example. the device 130 may receive the timestamp information from the device 110. Alternatively, the device 130 may receive the timestamp information from other device, for example, an Access and Mobility Management Function (AMF). In some embodiments, the device 130 may perform the second positioning measurement based on the timestamp information. For example, the device 130 may be scheduled for the second positioning measurement according to the timestamp information. In this case, in some embodiments, the device 130 and the device 120-1 may be scheduled for the positioning measurements at the same time. In other words, the first positioning measurement and the second positioning measurement may be performed at the same time. In this situation, the propagation environment for the first and second positioning measurements may not be changed, thereby improving accuracy. Alternatively, according to the timestamp information, the first positioning measurement and the second positioning measurement may not be performed at the same time. For example, the first positioning measurement may be performed at the first time instant, and the second positioning measurement may be performed at the second time instant. In this case, the first time instant and the second time instant are comparable. For example, a difference between the first and second time instants may be smaller than a threshold time period.

The second positioning measurement may be any suitable types of positioning measurement. For example, the second positioning measurement may comprise a round time trip (RTT). Alternatively, or in addition, the second positioning measurement may comprise an uplink time difference of arrival (UL-TDOA). In some example embodiments, the second positioning measurement may comprise a downlink time difference of arrival (DL-TDOA). In some other embodiments, the second positioning measurement may comprise a timing advance (TA). Alternatively, or in addition, the second positioning measurement may comprise an angle of arrival (AoA). In some example embodiments, the second positioning measurement may comprise an angle of departure (AoD). In some other embodiments, the second positioning measurement may comprise a global navigation satellite system (GNSS) measurement.

The device 130 transmits 2030 second measurement data which is based on at least one of the second measurement or a second result of the second measurement to the device 110. For example, the device 130 may transmit the second measurement data over ProvideLocationInformation LPP message. In some example embodiments, if the second positioning measurement is RTT measurement, the second measurement data may comprise a RTT measured by the device 130. In addition, in some example embodiments, the second measurement data may comprise the RTT result of the RTT measurement. Alternatively, or in addition, if the second positioning measurement is UL-TDOA, the second measurement data may comprise a UL-TDOA measured by the device 130. In addition, in some example embodiments, the second measurement data may comprise the UL-TDOA result of the UL-TDOA measurement. In some example embodiments, if the second positioning measurement is DL-TDOA, the second measurement data may comprise DL-TDOA measured by the device 130. In addition, in some example embodiments, the second measurement data may comprise the DL-TDOA result of the DL-TDOA measurement. In some other embodiments, if the second positioning measurement is a TA, the second measurement data may comprise a TA measured by the device 130. In addition, in some example embodiments, the second measurement data may comprise the TA result of the TA measurement. Alternatively, or in addition, if the second positioning measurement is an AoA, the second measurement data may comprise an AoA measured by the device 130. In addition, in some example embodiments, the second measurement data may comprise the AoA result of the AoA measurement. In some example embodiments, if the second positioning measurement is an AoD, the second measurement data may comprise an AoD measured by the device 130. In addition, in some example embodiments, the second measurement data may comprise the AoD result of the AoD measurement. In some other embodiments, if the second positioning measurement is a GNSS measurement, the second measurement data may comprise the GNSS information measured by the device 130. In addition, in some example embodiments, the second measurement data may comprise the GNSS result of the GNSS measurement.

In some example embodiments, the device 110 may store 2035 positioning process of the device 130. In some example embodiments, the device 110 may store the methods and measurement performed by the device 130. For example, as mentioned above, the second measurement may be RTT. In this case, the device 110 may store that the second measurement is RTT and the RTT valued measured by the device 130. In this way, is ensures the device 130 and the device 120 perform the same measurements.

In some example embodiments, the device 110 may determine 2040 an identity of the NTN device 140. For example, the device 110 may receive a new radio cell global identifier (NCGI) from a radio access network device. The device 110 may determine the identity of the NTN device 140 based on the NCGI. Alternatively, the device 110 may receive the identity of the non-terrestrial network device from a radio access network device.

The device 110 transmits 2045 first information comprising the identity of the NTN device 140 to the device 120-1. In some example embodiments, the first information may be transmitted in a long term evolution (LTE) positioning protocol (LPP) message. Alternatively, the first information may be transmitted in a downlink non-access stratum transport (DL_NAS_TRANSPORT) message. In other words, the device 110 may activate the device 120-1 and instruct the device 120-1 to use the same NTN device 120 as the device 130. The activation may be carried out by LPP or DL_NAS_TRANSPORT. It is noted that the transmission (2045) of the first information and the transmission (2030) second measurement data may take place in any suitable order. For example, as shown in FIG. 2, the transmission (2045) of the first information may be after the transmission (2030) second measurement data. Alternatively, the first information may be transmitted before the transmission (2030) second measurement data. In some other example embodiments, the first information may be transmitted at the same time as the transmission (2030) second measurement data.

The device 110 transmits 2050 second information to the device 120-1. The second information indicates a first positioning measurement configured for the device 120-1. The first positioning measurement is determined based on a second positioning measurement performed by the device 130 for the NTN device 140. In other words, the device 110 may request same types of measurements from the device 120-1 deployed nearby with same positioning method against same NTN device 140 as the device 130.

In some example embodiments, if the second positioning measurement is the RTT, the first positioning measurement may also be the RTT. Alternatively, or in addition, if the second positioning measurement is UL-TDOA, the first positioning measurement may also be the UL-TDOA. In some example embodiments, if the second positioning measurement is DL-TDOA, the first positioning measurement may also be the DL-TDOA. In some other embodiments, if the second positioning measurement is a TA, the first positioning measurement may also be the TA. Alternatively, or in addition, if the second positioning measurement is an AoA, the first positioning measurement may also be the AoA. In some example embodiments, if the second positioning measurement is an AoD, the first positioning measurement may also be the AoD. In some other embodiments, if the second positioning measurement is a GNSS measurement, the first positioning measurement may also be the GNSS measurement. In this way, it may ensure the device 120-1 receives the same assistance and reports the same measurements (RTT, UL/DL TDOA, TA, AoA/AoD, GNSS) against the same TRP (NTN satellite) and same visible GNSS satellites.

The NTN device 140 may transmit 2055 one or more PRSs to the device 120-1. The device 120-1 may monitor the plurality of PRRs based on the assistance information regarding PRS.

The device 120-1 performs 2060 a second positioning measurement based on the one or more PRSs from the NTN device 140. It is noted that the first positioning measurement and the second positioning measurement may be performed in any proper order. For example, as shown in FIG. 2, the first positioning measurement may be performed after the second positioning measurement is performed. Alternatively, the first positioning measurement and the second positioning measurement may be performed at the same time. In other embodiments, the first positioning measurement may be performed before the second positioning measurement is performed.

In some embodiments, the device 120-1 may determine timestamp information which is associated with the first and second positioning measurements. For example. the device 120-1 may receive the timestamp information from the device 110. Alternatively, the device 120-1 may receive the timestamp information from other device, for example, an Access and Mobility Management Function (AMF). In some embodiments, the device 120-1 may perform first second positioning measurement based on the timestamp information. For example, the device 120-1 may be scheduled for the first positioning measurement according to the timestamp information. In this case, in some embodiments, the device 130 and the device 120-1 may be scheduled for the positioning measurements at the same time. In other words, the first positioning measurement and the second positioning measurement may be performed at the same time. In this situation, the propagation environment for the first and second positioning measurements may not be changed, thereby improving accuracy. Alternatively, according to the timestamp information, the first positioning measurement and the second positioning measurement may not be performed at the same time. For example, the first positioning measurement may be performed at the first time instant, and the second positioning measurement may be performed at the second time instant. In this case, the first time instant and the second time instant are comparable. For example, a difference between the first and second time instants may be smaller than a threshold time period.

The device 120-1 transmits 2065 first measurement data which is based on at least one of the first measurement or a first result of the first measurement to the device 110. For example, the device 120-1 may transmit the second measurement data over ProvideLocationInformation LPP message. In some example embodiments, if the first positioning measurement is RTT measurement, the first measurement data may comprise a RTT measured by the device 120-1. In addition, in some example embodiments, the first measurement data may comprise the RTT result of the RTT measurement. Alternatively, or in addition, if the first positioning measurement is UL-TDOA, the first measurement data may comprise a UL-TDOA measured by the device 120-1. In addition, in some example embodiments, the first measurement data may comprise the UL-TDOA result of the UL-TDOA measurement. In some example embodiments, if the first positioning measurement is DL-TDOA, the first measurement data may comprise DL-TDOA measured by the device 120-1. In addition, in some example embodiments, the first measurement data may comprise the DL-TDOA result of the DL-TDOA measurement. In some other embodiments, if the first positioning measurement is a TA, the first measurement data may comprise a TA measured by the device 120-1. In addition, in some example embodiments, the first measurement data may comprise the TA result of the TA measurement. Alternatively, or in addition, if the first positioning measurement is an AoA, the first measurement data may comprise an AoA measured by the device 120-1. In addition, in some example embodiments, the first measurement data may comprise the AoA result of the AoA measurement. In some example embodiments, if the first positioning measurement is an AoD, the first measurement data may comprise an AoD measured by the device 120-1. In addition, in some example embodiments, the first measurement data may comprise the AoD result of the AoD measurement. In some other embodiments, if the first positioning measurement is a GNSS measurement, the first measurement data may comprise the GNSS information measured by the device 120-1. In addition, in some example embodiments, the first measurement data may comprise the GNSS result of the GNSS measurement.

The device 110 determines 2080 a verification of the location information of the device 130 based on the first and second measurement data. In this way, whether the location information is true can be verified. Moreover, since the device 120 doesn't depend on the device 130, all its measurements and location estimates are considered trustable. Based on these information and methods/locations that the device 120-1 is deployed, 5GC can ensure which side of the country border or which area the device 130 is located.

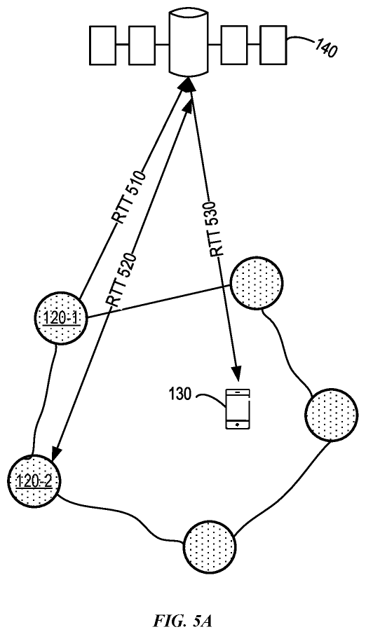

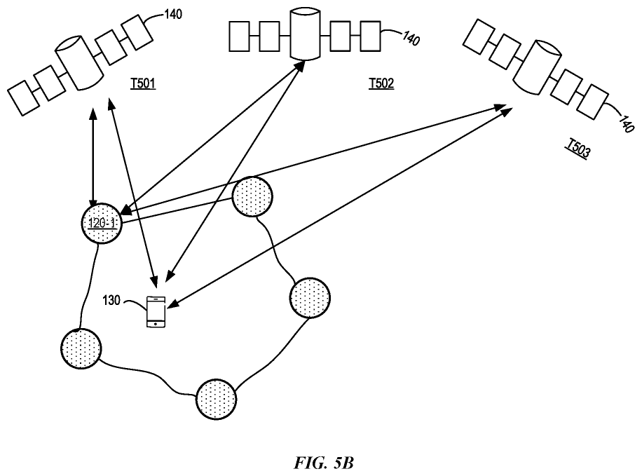

In some example embodiments, the device 110 may determine whether the second measurement data is within a range of the first measurement data. In this case, if the second measurement data is within the range of the first measurement data, the device 110 may determine that the location information of the device 130 is verified. Alternatively, if the second measurement data is out of the range of the first measurement data, the device 110 may determine that the location information of the device 130 is unverified. For example, if the location information indicates that the location of the device 130 is within the enclosed area (for example, the enclosed area 330), the second measurement data reported by the device 130 may be within the first measurement data from at least a pair of the second devices located on the border, which can be represented as Measurement_{device 120-j & NTN device 140}<Measurement_{device 130 & NTN device 140}<Measurement_{device 120-i & NTN device 140} and where i and j are integer numbers. The measurement may be one of: RTT, TA, RSTD, AoA, AoD or GNSS measurement. Only as an example, as shown in FIG. 5A, the RTT 510 measured by the device 120-1 may represent the RTT between the device 120-1 and the device 140, the RTT 520 measured by the device 120-2 may represent the RTT between the device 120-2 and the device 140, and the RTT 530 measured by the device 130 may represent the RTT between the device 130 and the device 140. In this case, the RTT 530 may be larger than the RTT 510 and smaller than the RTT 520.

Alternatively, the device 110 may determine a first equation based on the first measurement data and determine a second equation based on the second measurement data. The device 110 may combine the first and second equations. In this case, if a solution of the combined first and second equations is within an enclosed area defined by the at least one second device, the device 110 may determine that the location information of the third device is verified. Alternatively, if the solution is out of the enclosed area, the device 110 may determine that the location information of the third device is unverified. For example, if the location information indicates that the location of the device 130 is within the enclosed area (for example, the enclosed area 330), the corresponding equation (for example, including one of TA, RTT, RSTD, satellite TOA) reported by the device 130 may be consistent with measurements from the device(s) 120. In this case, if Equation(UE_{EQi}) comes from one of the measurements of the device 130, the device 120-1 has measurements' equations [PRU_{EQ1} . . . PRU_{EQn}], whether UE_{EQi} is consistent with PRUₖ can be decided by: putting UE_{EQi} into PRU equations: [UE_{EQi}, PRU_{EQ1} . . . PRU_{EQn}], the solution of the combined equations may be within the enclosed area as defined by Π(Pue−Pi)*Π(P_{PRUI}−Pi)>0, where P_{UE} represents the location of the device 130, P_{PRUi} represents the location of the device 120-I in the area which can be used to identify which side of the border the device 130 may be, and i can be any integer number.

In some example embodiments, the device 120-1 may perform the first positioning measurement more than one time. The device 120-1 may transmit 2070 third measurement data based on the reperformed first positioning measurement. In some example embodiments, the device 130 may perform the second positioning measurement more than one time. The device 130 may transmit 2075 fourth measurement data based on the reperformed second positioning measurement. In this case, the device 110 may determine 2080 the verification of the location information based on the third and fourth measurement data. For example, in case the measurements from the device(s) 120 and the device 130 is not synchronized for verification, since the satellite position changes continuously, interpolation can be used to make the measurements aligned with same timestamps. In this case, taking RTT as example, as shown in FIG. 5B, RTT_{PRUi & TRPi} can have consecutive measurements of [RTT_{device 120-1 & NTN device 140} (@time instant T501), RTT_{device 120-1 & NTN device 140} (@time instant T502), RTT_{device 120-1 & NTN device 140} (@time instant T503)]. The above measurements list can generate consecutive gradient/gap/difference list/series when one is subtracted from the next element: [ΔRTT_{device 120-1 & NTN device 140} (T502−T501), ΔRTT_{device 120-1 & NTN device 140} (T503−T502)]. Similarly, RTT_{device 130 & NTN device 140} can have consecutive measurements of [RTT_{device 130 & NTN device 140} (@T501), RTT_{device 130 & NTN device 140} (@T502), RTT_{device 130 & NTN device 140} (@T503)]. And the similar gradient/gap/difference list may be [ΔRTT_{device 130 & NTN device 140} (T502−T501), ΔRTT_{device 130 & NTN device 140} (T503−T502)]. For each time interval, the measurement gap/difference of the device 130 may be be within at least two devices 120 (the device 120-1 and the device 120-2) the measurements gaps/differences may be ΔRTT_{device 120-1 & NTN device 140} (Tₙ−Tₙ−1)<ΔRTT_{device 130 & NTN device 140} (Tₙ−Tₙ−1)<ΔRTT_{device 120-2 & NTN device 140} Tₙ−Tₙ−1), where n can be an integer number. It is noted that all other measurements including TA, RSTD, AoA/AoD and GNSS satellite measurements can be applied to above approach as well.

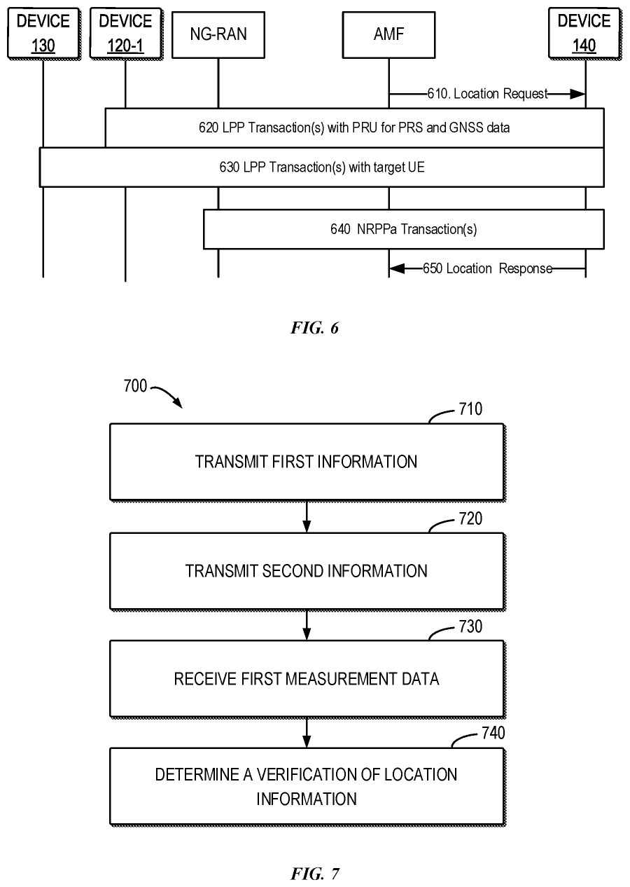

In some example embodiments, RSTD window determination and verification steps may also apply to codePhaseSearch Window in UE assisted A-GNSS methods. For example, as shown in FIG. 6, the AMF may transmit 610 a location request to the device 140. The device 140 may perform 620 LPP transaction(s) with PRU for PRS and GNSS data with the device 120-1. The device 140 may perform 630 LPP transaction(s) with the device 130. The device 140 may also perform 640 NRPPa transactions with the NG-RAN. The device 140 may then transmit 650 a location response to the AMF. In this way, it may speed up the measurements of the device 130. It could verify the location information of the device 130 with known GNSS environment, and with operator deployed PRU configuration and TRP topology.

It is noted that example embodiments described above can be implemented in any suitable manner. For example, example embodiments described above can be implemented separately. Alternatively, example embodiments described above can be combined in any suitable matter.

FIG. 7 illustrates a flow chart of method 700 of the present disclosure. The method 700 may be implemented at any suitable devices. For example, the method may be implemented at the device 110.

In some example embodiments, the device 110 may receive location information of the device 130 from the device 130. For example, the location information may indicate that the device 130 is located in country 102.

The device 110 may select one or more devices (for example, the devices 120-1 and 120-2) based on the location information of the device 110. In this way, it ensures that the devices can be selected properly.

In some example embodiments, the device 110 may transmit assistance information of positioning reference signal (PRS) measurement to the device 130 and the device 120. In some example embodiments, positioning assistance information may be broadcasted with pos system information block (SIB). In this case, the device 130 may perform the PRS and satellite measurements without explicit request to 5G core (5GC) before/during the registration. During the registration, the device 130 may take the ProvideLocationInformation LTE positioning protocol (LPP) message with PRS and satellite measurements with the registration request for satellite access. The LPP payload may be taken by registration request in initial UE message. The LPP payload may also be carried by a separate UL_NAS_TRANSPORT if ciphering key is available after registration request. When Access and Mobility Management Function (AMF) receives the registration request, the measurements in LPP message may be forwarded to the device 110 over NL1 interface with Nlmf_Location_DetermineLocation service operation. The device 110 may reply with the country indication and UEAreaIndication.

Alternatively, the device 110 may receive a request for a PRS measurement from the device 120-1. The device 110 then may transmit assistance information of positioning reference signal (PRS) measurement to the device 130 and the device 120-1.

In some example embodiments, the device 110 may transmit RequestLocationInformation asking for cell/satellite measurements instead of location estimate over LPP. The device 110 may also send NRPPa message POSITIONING INFORMATION REQUEST for UL measurements.

The device 110 may receive second measurement data which is based on the second measurement from the device 130. In some example embodiments, if the second positioning measurement is RTT measurement, the second measurement data may comprise a RTT measured by the device 130. Alternatively, or in addition, if the second positioning measurement is UL-TDOA, the second measurement data may comprise a UL-TDOA measured by the device 130. In some example embodiments, if the second positioning measurement is DL-TDOA, the second measurement data may comprise DL-TDOA measured by the device 130. In some other embodiments, if the second positioning measurement is a TA, the second measurement data may comprise a TA measured by the device 130. Alternatively, or in addition, if the second positioning measurement is an AoA, the second measurement data may comprise an AoA measured by the device 130. In some example embodiments, if the second positioning measurement is an AoD, the second measurement data may comprise an AoD measured by the device 130. In some other embodiments, if the second positioning measurement is a GNSS measurement, the second measurement data may comprise the GNSS information measured by the device 130.

In some example embodiments, the device 110 may store positioning process of the device 130. In some example embodiments, the device 110 may store the methods and measurement performed by the device 130. For example, as mentioned above, the second measurement may be RTT. In this case, the device 110 may store that the second measurement is RTT and the RTT valued measured by the device 130. In this way, is ensures the device 130 and the device 120 perform the same measurements.

In some example embodiments, the device 110 may determine an identity of the NTN device 140. For example, the device 110 may receive a new radio cell global identifier (NCGI) from a radio access network device. The device 110 may determine the identity of the NTN device 140 based on the NCGI. Alternatively, the device 110 may receive the identity of the non-terrestrial network device from a radio access network device.

At block 710, the device 110 transmits first information comprising the identity of the NTN device 140 to the device 120-1. In some example embodiments, the first information may be transmitted in a long term evolution (LTE) positioning protocol (LPP) message. Alternatively, the first information may be transmitted in a downlink non-access stratum transport (DL_NAS_TRANSPORT) message. In other words, the device 110 may activate the device 120-1 and instruct the device 120-1 to use the same NTN device 120 as the device 130. The activation may be carried out by LPP or DL_NAS TRANSPORT.

At block 720, the device 110 transmits second information to the device 120-1. The second information indicates a first positioning measurement configured for the device 120-1. The first positioning measurement is determined based on a second positioning measurement performed by the device 130 for the NTN device 140. In other words, the device 110 may request same types of measurements from the device 120-1 deployed nearby with same positioning method against same NTN device 140 as the device 130.

In some example embodiments, if the second positioning measurement is the RTT, the first positioning measurement may also be the RTT. Alternatively, or in addition, if the second positioning measurement is UL-TDOA, the first positioning measurement may also be the UL-TDOA. In some example embodiments, if the second positioning measurement is DL-TDOA, the first positioning measurement may also be the DL-TDOA. In some other embodiments, if the second positioning measurement is a TA, the first positioning measurement may also be the TA. Alternatively, or in addition, if the second positioning measurement is an AoA, the first positioning measurement may also be the AoA. In some example embodiments, if the second positioning measurement is an AoD, the first positioning measurement may also be the AoD. In some other embodiments, if the second positioning measurement is a GNSS measurement, the first positioning measurement may also be the GNSS measurement. In this way, it may ensure the device 120-1 receives the same assistance and reports the same measurements (RTT, UL/DL TDOA, TA, AoA/AoD, GNSS) against the same TRP (NTN satellite) and same visible GNSS satellites.

At block 730, the device 110 receives first measurement data which is based on the first measurement from the device 120-1. For example, the second measurement data may be received over ProvideLocationInformation LPP message. In some example embodiments, if the first positioning measurement is RTT measurement, the first measurement data may comprise a RTT measured by the device 120-1. Alternatively, or in addition, if the first positioning measurement is UL-TDOA, the first measurement data may comprise a UL-TDOA measured by the device 120-1. In some example embodiments, if the first positioning measurement is DL-TDOA, the first measurement data may comprise DL-TDOA measured by the device 120-1. In some other embodiments, if the first positioning measurement is a TA, the first measurement data may comprise a TA measured by the device 120-1. Alternatively, or in addition, if the first positioning measurement is an AoA, the first measurement data may comprise an AoA measured by the device 120-1. In some example embodiments, if the first positioning measurement is an AoD, the first measurement data may comprise an AoD measured by the device 120-1. In some other embodiments, if the first positioning measurement is a GNSS measurement, the first measurement data may comprise the GNSS information measured by the device 120-1.

At block 740, the device 110 determines a verification of the location information of the device 130 based on the first and second measurement data. In this way, whether the location information is true can be verified. Moreover, since the device 120 doesn't depend on the device 130, all its measurements and location estimates are considered trustable. Based on these information and methods/locations that the device 120-1 is deployed, 5GC can ensure which side of the country border or which area the device 130 is located.

In some example embodiments, the device 110 may determine whether the second measurement data is within a range of the first measurement data. In this case, if the second measurement data is within the range of the first measurement data, the device 110 may determine that the location information of the device 130 is verified. Alternatively, if the second measurement data is out of the range of the first measurement data, the device 110 may determine that the location information of the device 130 is unverified. For example, if the location information indicates that the location of the device 130 is within the enclosed area (for example, the enclosed area 330), the second measurement data reported by the device 130 may be within the first measurement data from at least a pair of the second devices located on the border, which can be represented as Measurement_{device 120-j & NTN device 140}<Measurement_{device 130 & NTN device 140}<Measurement_{device 120-i & NTN device 140} and where i and j are integer numbers. The measurement may be one of: RTT, TA, RSTD, AoA, AoD or GNSS measurement.

Alternatively, the device 110 may determine a first equation based on the first measurement data and determine a second equation based on the second measurement data. The device 110 may combine the first and second equations. In this case, if a solution of the combined first and second equations is within an enclosed area defined by the at least one second device, the device 110 may determine that the location information of the third device is verified. Alternatively, if the solution is out of the enclosed area, the device 110 may determine that the location information of the third device is unverified. For example, if the location information indicates that the location of the device 130 is within the enclosed area (for example, the enclosed area 330), the corresponding equation (for example, including one of TA, RTT, RSTD, satellite TOA) reported by the device 130 may be consistent with measurements from the device(s) 120. In this case, if Equation(UE_{EQi}) comes from one of the measurements of the device 130, the device 120-1 has measurements' equations [PRU_{EQ1} . . . PRU_{EQn}], whether UE_{EQi} is consistent with PRUₖ can be decided by: putting UE_{EQi} into PRU equations: [UE_{EQi}, PRU_{EQ1} . . . PRU_{EQn}], the solution of the combined equations may be within the enclosed area as defined by Π(Pue−Pi)*Π(P_{PRUI}−Pi)>0, where P_{UE} represents the location of the device 130, P_{PRUi} represents the location of the device 120-I in the area which can be used to identify which side of the border the device 130 may be, and i can be any integer number.

In some example embodiments, the device 110 may transmit receive third measurement data based on the reperformed first positioning measurement from the device 120-1. The device 130 may receive fourth measurement data based on the reperformed second positioning measurement from the device 130. In this case, the device 110 may determine the verification of the location information based on the third and fourth measurement data. For example, in case the measurements from the device(s) 120 and the device 130 is not synchronized for verification, since the satellite position changes continuously, interpolation can be used to make the measurements aligned with same timestamps.

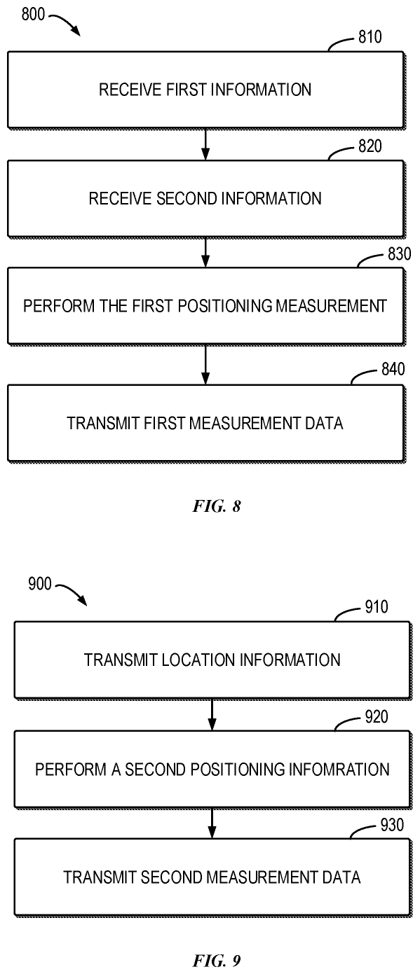

FIG. 8 illustrates a flow chart of method 800 of the present disclosure. The method 800 may be implemented at any suitable devices. For example, the method may be implemented at the device 120.

In some example embodiments, the device 120 may receive assistance information of positioning reference signal (PRS) measurement from the device 110. In some example embodiments, positioning assistance information may be broadcasted with pos system information block (SIB). In this case, the device 130 may perform the PRS and satellite measurements without explicit request to 5G core (5GC) before/during the registration. During the registration, the device 130 may take the ProvideLocationInformation LTE positioning protocol (LPP) message with PRS and satellite measurements with the registration request for satellite access. The LPP payload may be taken by registration request in initial UE message. The LPP payload may also be carried by a separate UL NAS_TRANSPORT if ciphering key is available after registration request.

Alternatively, the device 120-1 may transmit a request for a PRS measurement. The device 110 then may transmit assistance information of positioning reference signal (PRS) measurement to the device 130 and the device 120.

At block 810, the device 120-1 receives first information comprising the identity of the NTN device 140 from the device 110. In some example embodiments, the first information may be transmitted in a long term evolution (LTE) positioning protocol (LPP) message. Alternatively, the first information may be transmitted in a downlink non-access stratum transport (DL_NAS_TRANSPORT) message. In other words, the device 110 may activate the device 120-1 and instruct the device 120-1 to use the same NTN device 120 as the device 130. The activation may be carried out by LPP or DL_NAS TRANSPORT.

At block 820, the device 120-1 receives second information from the device 110. The second information indicates a first positioning measurement configured for the device 120-1. The first positioning measurement is determined based on a second positioning measurement performed by the device 130 for the NTN device 140. In other words, the device 110 may request same types of measurements from the device 120-1 deployed nearby with same positioning method against same NTN device 140 as the device 130.

In some example embodiments, if the second positioning measurement is the RTT, the first positioning measurement may also be the RTT. Alternatively, or in addition, if the second positioning measurement is UL-TDOA, the first positioning measurement may also be the UL-TDOA. In some example embodiments, if the second positioning measurement is DL-TDOA, the first positioning measurement may also be the DL-TDOA. In some other embodiments, if the second positioning measurement is a TA, the first positioning measurement may also be the TA. Alternatively, or in addition, if the second positioning measurement is an AoA, the first positioning measurement may also be the AoA. In some example embodiments, if the second positioning measurement is an AoD, the first positioning measurement may also be the AoD. In some other embodiments, if the second positioning measurement is a GNSS measurement, the first positioning measurement may also be the GNSS measurement. In this way, it may ensure the device 120-1 receives the same assistance and reports the same measurements (RTT, UL/DL TDOA, TA, AoA/AoD, GNSS) against the same TRP (NTN satellite) and same visible GNSS satellites.

At block 830, the device 120-1 performs a second positioning measurement based on the one or more PRSs from the NTN device 140. The 120-1 may receive one or more PRSs from the NTN device 140. The device 120-1 may monitor the plurality of PRRs based on the assistance information regarding PRS. In some embodiments, the device 120-1 may determine timestamp information which is associated with the first and second positioning measurements. For example. the device 120-1 may receive the timestamp information from the device 110. Alternatively, the device 120-1 may receive the timestamp information from other device, for example, an Access and Mobility Management Function (AMF). In some embodiments, the device 120-1 may perform first second positioning measurement based on the timestamp information. For example, the device 120-1 may be scheduled for the first positioning measurement according to the timestamp information. In this case, in some embodiments, the device 130 and the device 120-1 may be scheduled for the positioning measurements at the same time. In other words, the first positioning measurement and the second positioning measurement may be performed at the same time. In this situation, the propagation environment for the first and second positioning measurements may not be changed, thereby improving accuracy. Alternatively, according to the timestamp information, the first positioning measurement and the second positioning measurement may not be performed at the same time. For example, the first positioning measurement may be performed at the first time instant, and the second positioning measurement may be performed at the second time instant. In this case, the first time instant and the second time instant are comparable. For example, a difference between the first and second time instants may be smaller than a threshold time period.

At block 840, the device 120-1 transmits first measurement data which is based on the first measurement to the device 110. For example, the device 120-1 may transmit the second measurement data over ProvideLocationInformation LPP message. In some example embodiments, if the first positioning measurement is RTT measurement, the first measurement data may comprise a RTT measured by the device 120-1. Alternatively, or in addition, if the first positioning measurement is UL-TDOA, the first measurement data may comprise a UL-TDOA measured by the device 120-1. In some example embodiments, if the first positioning measurement is DL-TDOA, the first measurement data may comprise DL-TDOA measured by the device 120-1. In some other embodiments, if the first positioning measurement is a TA, the first measurement data may comprise a TA measured by the device 120-1. Alternatively, or in addition, if the first positioning measurement is an AoA, the first measurement data may comprise an AoA measured by the device 120-1. In some example embodiments, if the first positioning measurement is an AoD, the first measurement data may comprise an AoD measured by the device 120-1. In some other embodiments, if the first positioning measurement is a GNSS measurement, the first measurement data may comprise the GNSS information measured by the device 120-1.

In some example embodiments, the device 120-1 may perform the first positioning measurement more than one time. The device 120-1 may transmit 2070 third measurement data based on the reperformed first positioning measurement.

FIG. 9 illustrates a flow chart of method 900 of the present disclosure. The method 900 can be implemented at any suitable devices. For example, the method may be implemented at the device 130.

At block 910, the device 130 transmits its location information to the device 110. For example, the location information may indicate that the device 130 is located in country 102.

In some example embodiments, the device 130 may receive assistance information of positioning reference signal (PRS) measurement from the device 110. In some example embodiments, positioning assistance information may be broadcasted with pos system information block (SIB). In this case, the device 130 may perform the PRS and satellite measurements without explicit request to 5G core (5GC) before/during the registration. During the registration, the device 130 may take the ProvideLocationInformation LTE positioning protocol (LPP) message with PRS and satellite measurements with the registration request for satellite access. The LPP payload may be taken by registration request in initial UE message. The LPP payload may also be carried by a separate UL NAS_TRANSPORT if ciphering key is available after registration request.

In some example embodiments, the device 130 may receive one or more PRSs from the NTN device 140. The device 130 may monitor the plurality of PRRs based on the assistance information regarding PRS.

At block 920, the device 130 performs a second positioning measurement based on the one or more PRSs from the NTN device 140. In some embodiments, the device 130 may determine timestamp information which is associated with the first and second positioning measurements. For example. the device 130 may receive the timestamp information from the device 110. Alternatively, the device 130 may receive the timestamp information from other device, for example, an Access and Mobility Management Function (AMF). In some embodiments, the device 130 may perform the second positioning measurement based on the timestamp information. For example, the device 130 may be scheduled for the second positioning measurement according to the timestamp information. In this case, in some embodiments, the device 130 and the device 120-1 may be scheduled for the positioning measurements at the same time. In other words, the first positioning measurement and the second positioning measurement may be performed at the same time. In this situation, the propagation environment for the first and second positioning measurements may not be changed, thereby improving accuracy. Alternatively, according to the timestamp information, the first positioning measurement and the second positioning measurement may not be performed at the same time. For example, the first positioning measurement may be performed at the first time instant, and the second positioning measurement may be performed at the second time instant. In this case, the first time instant and the second time instant are comparable. For example, a difference between the first and second time instants may be smaller than a threshold time period.

The second positioning measurement may be any suitable types of positioning measurement. For example, the second positioning measurement may comprise a round time trip (RTT). Alternatively, or in addition, the second positioning measurement may comprise an uplink time difference of arrival (UL-TDOA). In some example embodiments, the second positioning measurement may comprise a downlink time difference of arrival (DL-TDOA). In some other embodiments, the second positioning measurement may comprise a timing advance (TA). Alternatively, or in addition, the second positioning measurement may comprise an angle of arrival (AoA). In some example embodiments, the second positioning measurement may comprise an angle of departure (AoD). In some other embodiments, the second positioning measurement may comprise a global navigation satellite system (GNSS) measurement.

At block 930, the device 130 transmits second measurement data which is based on the second measurement to the device 110. For example, the device 130 may transmit the second measurement data over ProvideLocationInformation LPP message. In some example embodiments, if the second positioning measurement is RTT measurement, the second measurement data may comprise a RTT measured by the device 130. Alternatively, or in addition, if the second positioning measurement is UL-TDOA, the second measurement data may comprise a UL-TDOA measured by the device 130. In some example embodiments, if the second positioning measurement is DL-TDOA, the second measurement data may comprise DL-TDOA measured by the device 130. In some other embodiments, if the second positioning measurement is a TA, the second measurement data may comprise a TA measured by the device 130. Alternatively, or in addition, if the second positioning measurement is an AoA, the second measurement data may comprise an AoA measured by the device 130. In some example embodiments, if the second positioning measurement is an AoD, the second measurement data may comprise an AoD measured by the device 130. In some other embodiments, if the second positioning measurement is a GNSS measurement, the second measurement data may comprise the GNSS information measured by the device 130.

In some example embodiments, the device 130 may perform the second positioning measurement more than one time. The device 130 may transmit fourth measurement data based on the reperformed second positioning measurement.

In some example embodiments, an apparatus for performing the method 700 (for example, the device 110) may include respective means for performing the corresponding steps in the method 700. These means may be implemented in any suitable manners. For example, it can be implemented by circuitry or software modules.

In some example embodiments, the apparatus comprises means for transmitting, at a first device, first information to at least one second device, the first information comprising an identity of a non-terrestrial network device to which a third device connects; means for transmitting second information to the at least one second device, the second information indicating a first positioning measurement configured for the at least one second device, and the first positioning measurement being determined based on a second positioning measurement performed by the third device for the non-terrestrial network device; means for receiving from the at least one second device first measurement data which is determined based on the first positioning measurement; and means for determining a verification of location information of the third device based on the first measurement data and second measurement data which is determined based on the second positioning measurement.

In some example embodiments, the first positioning measurement comprises at least one of: a round time trip (RTT), an uplink time difference of arrival (UL-TDOA), a downlink time difference of arrival (DL-TDOA), a timing advance (TA), an angle of arrival (AoA), an angle of departure (AoD), or a global navigation satellite system (GNSS) measurement.

In some example embodiments, the first information is transmitted in a long term evolution (LTE) positioning protocol (LPP) message or a downlink non-access stratum transport (DL_NAS_TRANSPORT) message.

In some example embodiments, the apparatus comprises means for receiving a new radio cell global identifier (NCGI) from a radio access network device; and means for determining the identity of the non-terrestrial network device based on the NCGI.

In some example embodiments, the apparatus comprises means for receiving the identity of the non-terrestrial network device from a radio access network device.

In some example embodiments, the apparatus comprises means for receiving, from the at least one second device, a request for a positioning reference signal (PRS) measurement; and means for transmitting to the at least one second and third devices assistance information regarding the PRS measurement.

In some example embodiments, the apparatus comprises means for receiving from the third device the location information of the third device; and means for selecting the at least one second device based on the location.

In some example embodiments, the means for determining the verification of the location information of the third device comprises means for determining whether the second measurement data is within a range of the first measurement data; and means for in accordance with a determination that the second measurement data is within the range of the first measurement data, determining that the location information of the third device is verified; or means for in accordance with a determination that the second measurement data is out of the range of the first measurement data, determining that the location information of the third device is unverified.

In some example embodiments, the means for determining the verification of the location information of the third device comprises means for determining a first equation based on the first measurement data; means for determining a second equation based on the second measurement data; means for combining the first and second equations; and means for in accordance with a determination that a solution of the combined first and second equations is within an enclosed area defined by the at least one second device, determining that the location information of the third device is verified; or means for in accordance with a determination that the solution is out of the enclosed area, determining that the location information of the third device is unverified.

In some example embodiments, the apparatus comprises means for receiving from the at least one second device third measurement data which is determined based on the first positioning measurement, after the reception of the first measurement data; means for receiving from the third device fourth measurement data which is determined based on the second positioning measurement, after a reception of the second measurement data; and means for determining the verification of the location information based on the third and fourth measurement data.

In some example embodiments, the first device comprises a core network device, the at least one second device comprises at least one positioning reference unit, and the third device comprises a terminal device.

In some example embodiments, an apparatus for performing the method 800 (for example, the device 120) may include respective means for performing the corresponding steps in the method 800. These means may be implemented in any suitable manners. For example, it can be implemented by circuitry or software modules.

In some example embodiments, the apparatus comprises means for receiving, at a second device, first information from a first device, the first information comprising an identity of a non-terrestrial network device to which a third device connects; means for receiving second information from the first device, the second information indicating a first positioning measurement configured for the at least one second device, and the first positioning measurement being determined based on a second positioning measurement performed by the third device for the non-terrestrial network device; means for performing the first positioning measurement based on a positioning reference signal from the non-terrestrial network device; and means for transmitting to the first device first measurement data determined based on at least one of: the first positioning measurement or a first result of the first positioning measurement.

In some example embodiments, the first positioning measurement comprises at least one of: a round time trip (RTT), an uplink time difference of arrival (UL-TDOA), a downlink time difference of arrival (DL-TDOA), a timing advance (TA), an angle of arrival (AoA), an angle of departure (AoD), or a global navigation satellite system (GNSS) measurement.

In some example embodiments, the first information is received in a long term evolution (LTE) positioning protocol (LPP) message or a downlink non-access stratum transport (DL_NAS_TRANSPORT) message.

In some example embodiments, the apparatus comprises means for reperforming the first positioning measurement; and means for transmitting third measurement data which is determined based on the reperformed first positioning measurement.

In some example embodiments, the apparatus comprises means for transmitting, to the first device, a request for a positioning reference signal (PRS) measurement; and means for receiving from the first device assistance information regarding the PRS measurement.

In some example embodiments, the apparatus comprises means for determining timestamp information which is associated with the first and second positioning measurements; and means for performing the first positioning measurement based on the timestamp information.

In some example embodiments, the first device comprises a core network device, the at least one second device comprises at least one positioning reference unit, and the third device comprises a terminal device.

In some example embodiments, an apparatus for performing the method 900 (for example, the device 130) may include respective means for performing the corresponding steps in the method 900. These means may be implemented in any suitable manners. For example, it can be implemented by circuitry or software modules.

In some example embodiments, the apparatus comprises means for transmitting, at a third device, location information of the third device to a first device; means for performing a second positioning measurement based on a positioning reference signal from a non-terrestrial network device; and means for transmitting to the first device second measurement data which is determined based on at least one of: the second positioning measurement or a second result of the second positioning measurement.

In some example embodiments, the second positioning measurement comprises at least one of: a round time trip (RTT), an uplink time difference of arrival (UL-TDOA), a downlink time difference of arrival (DL-TDOA), a timing advance (TA), an angle of arrival (AoA), an angle of departure (AoD), or a global navigation satellite system (GNSS) measurement.

In some example embodiments, the apparatus comprises means for reperforming the second positioning measurement; and means for transmitting fourth measurement data which is determined based on the reperformed second positioning measurement.

In some example embodiments, the apparatus comprises means for determining timestamp information which is associated with a first positioning measurement performed by a second device and the second positioning measurement; and means for performing the second positioning measurement based on the timestamp information.

In some example embodiments, the first device comprises a core network device, and the third device comprises a terminal device.

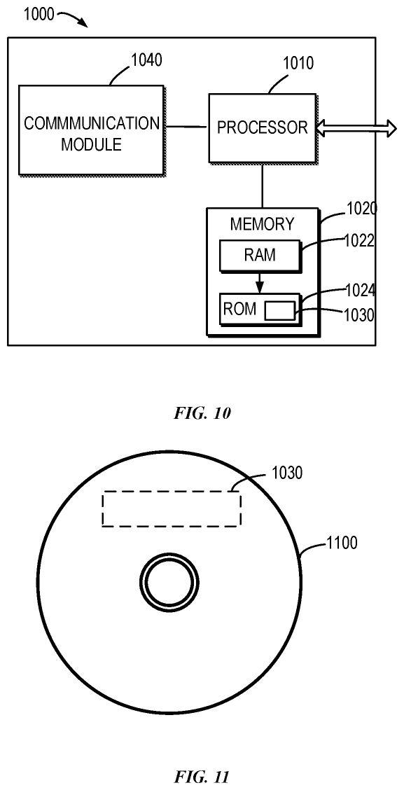

FIG. 10 is a simplified block diagram of a device 1000 that is suitable for implementing embodiments of the present disclosure. The device 1000 may be provided to implement the communication device, for example the device 110, the device 120, or the device 130 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1020 so that the device 1000 may perform any process of the disclosure as discussed with reference to FIGS. 2 and 9. The embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods as described above with reference to FIG. 2-FIG. 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions of a location management function, the instructions, when executed by the at least one processor, causing the first device at least to perform operations, the operations comprising:
transmitting first information to at least one positioning reference unit, the first information comprising an identity of a non-terrestrial network device to which a terminal device connects;
transmitting second information to the at least one positioning reference unit, the second information indicating a first positioning measurement to be configured for the at least one positioning reference unit, the information indicating the first positioning measurement being determined based on information indicating a second positioning measurement performed by the terminal device for the non-terrestrial network device;
receiving, from the at least one positioning reference unit, first measurement data which is determined based on the first positioning measurement; and
determining a verification of location information of the terminal device based on the first measurement data and second measurement data which is based on the second positioning measurement.

2. The first device of claim 1, wherein the first positioning measurement comprises at least one of the following:
measurement of a round time trip,
measurement of an uplink time difference of arrival,
measurement of a downlink time difference of arrival,
measurement of a timing advance,
measurement of an angle of arrival,
measurement of an angle of departure, or
a global navigation satellite system measurement.

3. The first device of claim 1, wherein the first information is transmitted in a long term evolution positioning protocol message or a downlink non-access stratum transport message.

4. The first device of claim 1, wherein the operations further comprise:
receiving a radio cell global identifier from a radio access network device; and
determining the identity of the non-terrestrial network device based on the radio cell global identifier.

5. The first device of claim 1, wherein the operations further comprise:
receiving the identity of the non-terrestrial network device from a radio access network device.

6. The first device of claim 1, wherein the operations further comprise:
receiving, from a positioning reference unit of the at least one positioning reference unit, a request for a positioning reference signal measurement; and
transmitting, to the at least one positioning reference unit and the terminal device, assistance information regarding the positioning reference signal measurement.

7. The first device of claim 1, wherein the operations further comprise:
receiving, from the terminal device, the location information of the terminal device; and
selecting the at least one positioning reference unit based on the location information of the terminal device.

8. The first device of claim 1, wherein the determining the verification comprises:
determining whether the second measurement data is within a range of the first measurement data; and
in accordance with a determination that the second measurement data is within the range of the first measurement data, determining that the location information of the terminal device is verified; or
in accordance with a determination that the second measurement data is out of the range of the first measurement data, determining that the location information of the terminal device is unverified.

9. The first device of claim 1, wherein the determining the verification comprises:
determining a first equation based on the first measurement data;
determining a second equation based on the second measurement data;
combining the first equation and the second equation to form a combined equation; and
in accordance with a determination that a solution of the combined equation is within an enclosed area defined by the at least one positioning reference unit, determining that the location information of the terminal device is verified; or
in accordance with a determination that the solution is out of the enclosed area, determining that the location information of the terminal device is unverified.

10. The first device of claim 1, wherein the operations further comprise:
receiving, from the at least one positioning reference unit, third measurement data which is determined based on the first positioning measurement, after the reception of the first measurement data;
receiving, from the terminal device, fourth measurement data which is determined based on the second positioning measurement, after a reception of the second measurement data; and
determining the verification of the location information based on the third measurement data and the fourth measurement data.

11.-23. (canceled)

24. A method of a first device comprising a location management function, the method comprising:
transmitting first information to at least one positioning reference unit, the first information comprising an identity of a non-terrestrial network device to which a terminal device connects;
transmitting second information to the at least one positioning reference unit, the second information indicating a first positioning measurement to be configured for the at least one positioning reference unit, the information indicating the first positioning measurement being determined based on information indicating a second positioning measurement performed by the terminal device for the non-terrestrial network device;
receiving, from the at least one positioning reference unit, first measurement data which is determined based on the first positioning measurement; and
determining a verification of location information of the terminal device based on the first measurement data and second measurement data which is based on the second positioning measurement.

25. The method of claim 24, wherein the first positioning measurement comprises at least one of the following:
measurement of a round time trip,
measurement of an uplink time difference of arrival,
measurement of a downlink time difference of arrival,
measurement of a timing advance,
measurement of an angle of arrival,
measurement of an angle of departure, or
a global navigation satellite system measurement.

26. The method of claim 24, wherein the first information is transmitted in a long term evolution positioning protocol message or a downlink non-access stratum transport message.

27. The method of claim 24, further comprising:
receiving a radio cell global identifier from a radio access network device; and
determining the identity of the non-terrestrial network device based on the radio cell global identifier.

28. The method of claim 24, further comprising:
receiving the identity of the non-terrestrial network device from a radio access network device.

29. The method of claim 24, further comprising
receiving, from a positioning reference unit of the at least one positioning reference unit, a request for a positioning reference signal measurement; and
transmitting, to the at least one positioning reference unit and the terminal device, assistance information regarding the positioning reference signal measurement.

30. The method of claim 24, further comprising:
receiving, from the terminal device, the location information of the terminal device; and
selecting the at least one positioning reference unit based on the location information of the terminal device.

31. The method of claim 24, wherein determining the verification of the location information of the third device comprises:
determining whether the second measurement data is within a range of the first measurement data; and
in accordance with a determination that the second measurement data is within the range of the first measurement data, determining that the location information of the terminal device is verified; or
in accordance with a determination that the second measurement data is out of the range of the first measurement data, determining that the location information of the terminal device is unverified.

32. The method of claim 24, wherein determining the verification of the location information of the third device comprises:
determining a first equation based on the first measurement data;
determining a second equation based on the second measurement data;
combining the first equation and the second equation to form a combined equation; and
in accordance with a determination that a solution of the combined equation is within an enclosed area defined by the at least one positioning reference unit, determining that the location information of the terminal device is verified; or
in accordance with a determination that the solution is out of the enclosed area, determining that the location information of the terminal device is unverified.

33. The method of claim 24, further comprising:
receiving, from the at least one positioning reference unit, third measurement data which is determined based on the first positioning measurement, after the reception of the first measurement data;
receiving, from the terminal device, fourth measurement data which is determined based on the second positioning measurement, after a reception of the second measurement data; and
determining the verification of the location information based on the third measurement data and the fourth measurement data.

34.-50. (canceled)
